(19) United States
(12) Patent Application Publication
(10) Pub. No.: US 2025/0252259 A1
(43) Pub. Date: Aug. 7, 2025

(54) STRUCTURAL DATA EXTRACTION AND CLASSIFICATION FROM UNSTRUCTURED TEXT STREAMS

(71) Applicant: Airbnb, Inc., San Francisco, CA (US)

(72) Inventors: Hongwei Li, Albany, CA (US); Peng Wang, Bellevue, WA (US)

(21) Appl. No.: 18/432,571

(22) Filed: Feb. 5, 2024

(51) Int. Cl. G06Q 10/02; G06F 40/263; G06F 40/284; G06F 40/295

(52) U.S. Cl. CPC G06F 40/284; G06F 40/263; G06F 40/295; G06Q 30/0625; G06Q 10/02

(57) ABSTRACT

Systems and methods are provided. In one example, a method includes receiving unstructured text documents associated with a plurality of listings hosted on a listing network platform. For each listing in the plurality of listings, the method further includes analyzing the unstructured text documents to detect named entities corresponding to one or more entity types using a first trained neural network model. The method additionally includes mapping the detected named entities to a standardized taxonomy of listing attributes by using a mapping space. The method also includes storing, in a searchable knowledge base, the mapped listing attributes to refer to corresponding listings in the plurality of listings, and providing, via the one or more processors, for a search facility to search the searchable knowledge base for one or more listings in the plurality of listings having a listing attribute.

### TECHNICAL FIELD

Embodiments herein generally relate to practical applications of text data analysis and manipulation. More specifically, but not by way of limitation, systems and methods herein describe applications for structural data extraction and classification from unstructured text streams.

### BACKGROUND

Online booking systems include data analysis and data manipulation systems that are used to review, for example, booking data to make informed decisions before purchasing a good or service. Improved data analysis of certain data, such as textual data, increases overall performance and the reach of such online booking systems.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a block diagram illustrating operations of a Listing Attribute Extraction Platform (LAEP) system, according to some examples.

FIG. 3 is a block diagram depicting a text processing pipeline suitable for implementing a Named Entity Recognition (NER) system, according to some examples.

FIG. 4 is a flowchart of an entity mapping process suitable for mapping entities to listing attributes, according to some examples.

FIG. 5 illustrates a semantic vector space suitable for use in mapping named entities into a standardized taxonomy of listing attributes, according to some examples.

FIG. 6 is a flowchart of a process suitable for determining if an entity is present in a listing, according to some examples.

FIG. 7 is a block diagram illustrating details of a Bidirectional Encoder Representation from Transformers (BERT) model, according to some examples.

FIG. 8 is a flowchart of a process suitable for providing a searchable knowledge base of listing attributes, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

### DETAILED DESCRIPTION

The following paragraphs describe systems and methods for deriving structured text and for classifying the structured text, such as text data from a listing network platform. The listing network platform allows host users to list or publish their homes or hotels for temporary stays, and includes one or more text streams, such as a listing description stream, a review stream, messaging streams, and so on. The techniques described herein result in practical applications, such as systems and methods that extract structured data from unstructured text using machine learning techniques. In certain examples, a Listing Attribute Extraction Platform (LAEP) system is described, suitable for extracting information about listings, such as rental listings, on the listing network platform from free-form text data.

In some examples, the LAEP system includes three main components:

A Named Entity Recognition (NER) system that identifies and classifies key phrases in unstructured text into predefined categories such as amenities, events, locations, and the like. For example, if a guest message in the listing network platform asks, “Does your listing have a swimming pool?”, the phrase “swimming pool” would be detected as an entity with the type “Amenity”. The NER system is implemented using neural network models such as transformer models and convolutional neural network models.

An Entity Mapping (EM) system that maps the detected key phrases to a structured taxonomy of listing attributes maintained by the listing network platform. The EM system leverages unsupervised learning techniques based on word embeddings and semantic similarity. For example, a word-embedding space is created and used to determine distances in the space between a candidate word and a word stored in the taxonomy. For example, words like “secure box” and “lockable box” would be mapped via the EM system to the word “lockbox.”

An Entity Scoring(ES) system that derives certain metadata related to the listing attribute (e.g., word) being analyzed, such as such as if the listing attribute actually exists in the subject listing or not, if it is usable or not, if it is of a certain type (e.g., kitchen amenity) or not, and so on. In some examples, the ES system employs supervised learning using a fine-tuned Bidirectional Encoder Representation from Transformers (BERT) models to perform contextual text classification.

In operation, the LAEP system takes unstructured text data associated with listings, such as listing descriptions, guest reviews, messaging transcripts, and so on, as input. The LAEP system then applies the NER system, the EM system, and the ES system to extract structured information about listing attributes. The output data is then utilized by downstream applications to enhance search, provide recommendations, and to improve the overall guest experience. By automating the extraction of useful metadata about listings from heterogeneous text data, the present techniques help hosts accurately showcase their listings and enable guests to discover more ideal stays in a personalized manner. The LAEP system is highly scalable and enhances accuracy over manual data entry.

### Networked Computing Environment

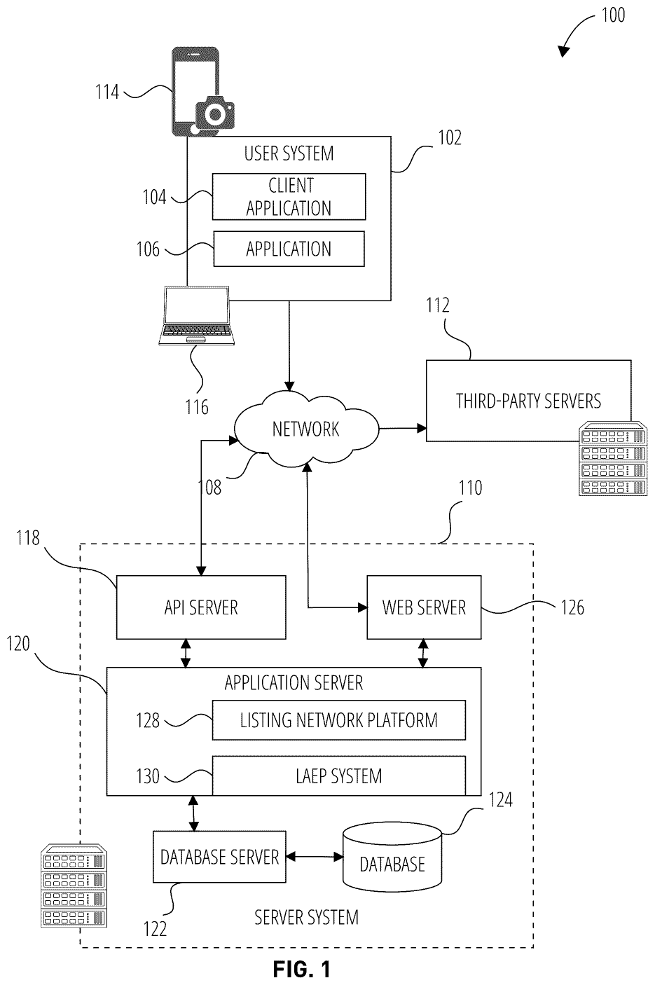

FIG. 1 is a block diagram showing an example networked system 100 for facilitating listing services (e.g., publishing goods or services for sale or barter, purchases of goods or services) over a network, in accordance with some examples. The networked system 100 includes multiple user systems 102, each of which hosts multiple applications, including a client application 104 and other applications 106. Each client application 104 is communicatively coupled, via one or more communication networks including a network 108 (e.g., the Internet), to other instances of the client application 104 (e.g., hosted on respective other user systems 102), a server system 110 and third-party servers 112). A client application 104 can also communicate with locally hosted applications 106 using Applications Program Interfaces (APIs).

Each user system 102 may include multiple user devices, such as a mobile device 114 and a computer client device 116 that are communicatively connected to exchange data and messages.

A client application 104 interacts with other client applications 104 and with the server system 110 via the network 108. The data exchanged between the client applications 104 and between the client applications 104 and the server system 110 includes functions (e.g., commands to invoke functions) and payload data (e.g., text, audio, video, or other multimedia data).

In some example embodiments, the client application 104 is a reservation application for temporary stays or experiences at hotels, motels, or residences managed by other end users (e.g., a posting end user who owns a home and rents out the entire home or private room). In some implementations, the client application(s) client application 104 include various components operable to present information to the user and communicate with the networked system 102. In some embodiments, if the reservation application is included in the client device 116, then this application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment). Conversely, if the reservation application is not included in the client device 116, the client device 116 can use its web browser to access the e-commerce site (or a variant thereof) hosted on the networked system 102.

The server system 110 provides server-side functionality via the network 108 to the client applications 104. While certain functions of the networked system 100 are described herein as being performed by either a client application 104 or by the server system 110, the location of certain functionality either within the client application 104 or the server system 110 may be a design choice. For example, it may be technically preferable to initially deploy particular technology and functionality within the server system 110 but to later migrate this technology and functionality to the client application 104 where a user system 102 has sufficient processing capacity.

The server system 110 supports various services and operations that are provided to the client application 104. Such operations include transmitting data to, receiving data from, and processing data generated by the client applications 104. This data may include message content, client device information, geolocation information, reservation information, transaction information, message content. Data exchanges within the networked system 100 are invoked and controlled through functions available via user interfaces (UIs) of the client application 104.

Turning now specifically to the server system 110, an Application Program Interface (API) server 118 is coupled to and provides programmatic interfaces to application server 120, making the functions of the application server 120 accessible to the client application 104, other applications 106 and third-party server 112. The application server 120 are communicatively coupled to a database server 122, facilitating access to a database 124 that stores data associated with interactions processed by the application server 120. Similarly, a web server 126 is coupled to the application server 120 and provides web-based interfaces to the application server 120. To this end, the web server 126 processes incoming network requests over the Hypertext Transfer Protocol (HTTP) and several other related protocols.

The Application Program Interface (API) server 118 receives and transmits interaction data (e.g., commands and message payloads) between the application server 120 and the user systems 102 (and, for example, interaction clients 104 and other application 106) and the third-party server 112. Specifically, the Application Program Interface (API) server 118 provides a set of interfaces (e.g., routines and protocols) that can be called or queried by the client application 104 and other applications 106 to invoke functionality of the application server 120. The Application Program Interface (API) server 118 exposes various functions supported by the application server 120, including account registration; login functionality.

The application server 120 hosts the listing network platform 128 and a LAEP system 130 each of which comprises one or more modules or applications and each of which can be embodied as hardware, software, firmware, or any combination thereof. The application server 120 is shown to be coupled to a database server 122 that facilitates access to one or more information storage repositories or database(s) 124.

The listing network platform 128 provides a number of publication functions and listing services to the users who access the networked system 100. While the listing network platform 128 is shown in FIG. 1 to form part of the networked system 100, it will be appreciated that, in alternative embodiments, the listing network platform 128 may form part of a web service that is separate and distinct from the networked system 100. The listing network platform 128 can be hosted on dedicated or shared server machines that are communicatively coupled to enable communications between server machines. The listing network platform 128 provides a number of publishing and listing mechanisms whereby a seller (also referred to as a “first user,” posting user, host) may list (or publish information concerning) goods or services for sale or barter, a buyer (also referred to as a “second user,” searching user, guest) can express interest in or indicate a desire to purchase or barter such goods or services, and a transaction (such as a trade) may be completed pertaining to the goods or services.

The LAEP system 130 uses neural network techniques to more efficiently process large volumes of data captured by the listing network platform 128. For example, raw text data found in listing descriptions, check-in instructions, guest reviews, messaging, and so on, are analyzed to extract and to categorize structured data representative of listing entities. The listing entities include entity types such as amenities, point-of-interest, activities, and the like. Metadata is also created that provides further information for each entity, such as existence in the subject listing or not, usability, if it is of a certain type (e.g., amenity), confidence level, and the like. The output data is then utilized by downstream applications, including the listing network platform 128, to enhance listing searches, to provide recommendations, and to improve the overall guest experience.

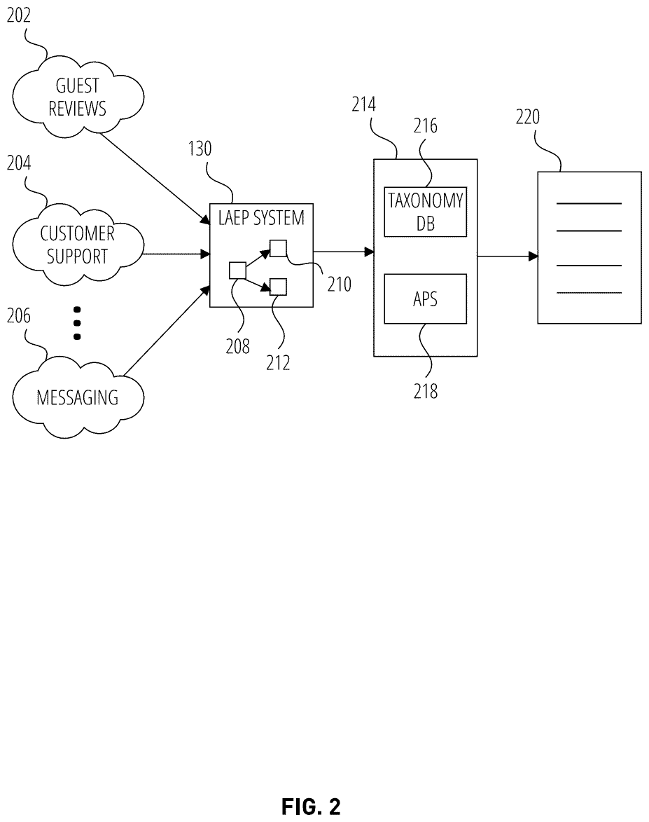

FIG. 2 is a block diagram illustrating operations of the LAEP system 130, according to some examples. In the depicted embodiment, the LAEP system 130 receives as input text data from various sources included in the listing network platform 128, such as guest reviews 202, customer support 204, messaging 206, and so on. As mentioned earlier, the LAEP system 130 includes a Named Entity Recognition (NER) 208, an Entity Mapping (EM) system 210, and an Entity Scoring(ES) system 212 for extracting structured data.

The NER system 208 is responsible for identifying and classifying entities or key phrases within the inputted unstructured text data into predefined categories relevant to the listing network platform 128. In some examples, six types of entities are identified, which include an amenity type, a facility type, a hospitality type, a location features type, a safety and security type, and a structural details type. It is to be understood that more or fewer types can be identified in example embodiments. The amenity type is used to describe listing amenities such as a pool, WiFi, a kitchen, a coffee maker, a washer, a dryer, and so on. The facility type is used to describe access to certain facilities, such as a free parking spot, an outdoor gazebo, and so on. The hospitality type is used to describe the type of hospitality business for the listing, such as luggage storage, breakfast, airport pickup, and so on. The location features type is used to describe parks, beaches, coffee shops, stadiums, and so on, located nearby. The safety and security type is used to describe the presence of home alarms, lockboxes, carbon monoxide detectors, and the like, available in the listing. The structural details type describes structure type(s) in the listing, such as a condominium, a townhome, an apartment, and so on.

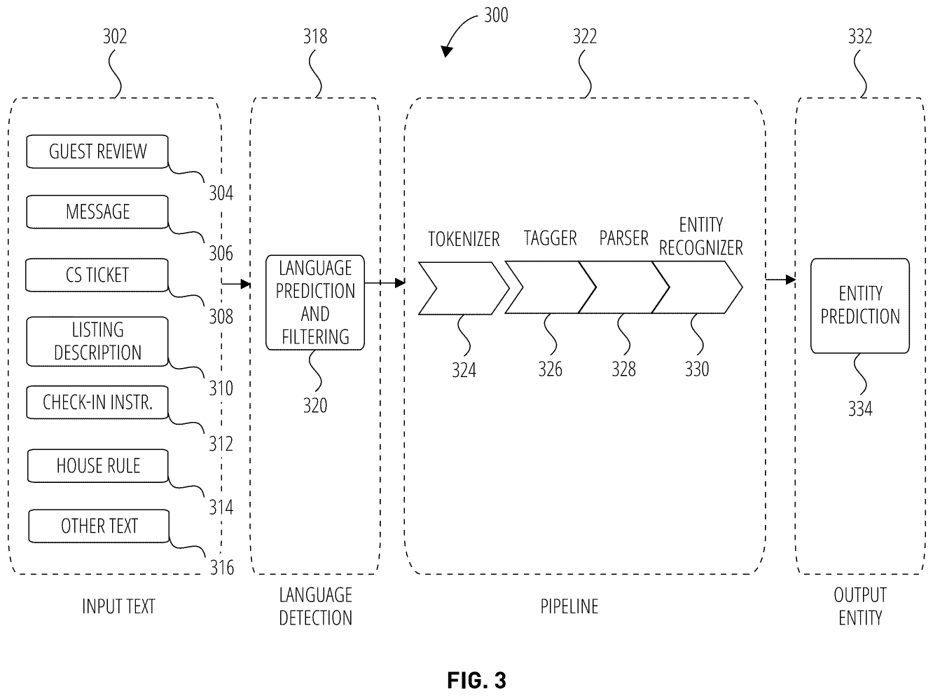

The NER system 208 includes a NER model, further described below. To apply the NER model, texts are collected from various sources, such as guest reviews 202, customer support tickets 204, messaging 206, and so on. A text processing pipeline is used, that sequentially processes the input texts to provide for language detection, tokenization, and entity detection. Details of the text processing pipeline are shown below with respect to FIG. 3. Detected entities are then provided to the EM system 210 and the ES system 212. As referred to herein, an entity is a key phrase or object detected by the NER system 208 from inputs that include unstructured text such as free form text. Some entity examples include “locking box”, “swimming pool”, “baby crib”, “coffee making machine”, and so on. An attribute is a standardized entity, such as “lockbox”, “pool”, “crib”, “coffee maker.” That is, entities are textual references to objects/places/amenities extracted from unstructured descriptions, while attributes are standardized entities used to describe listings.

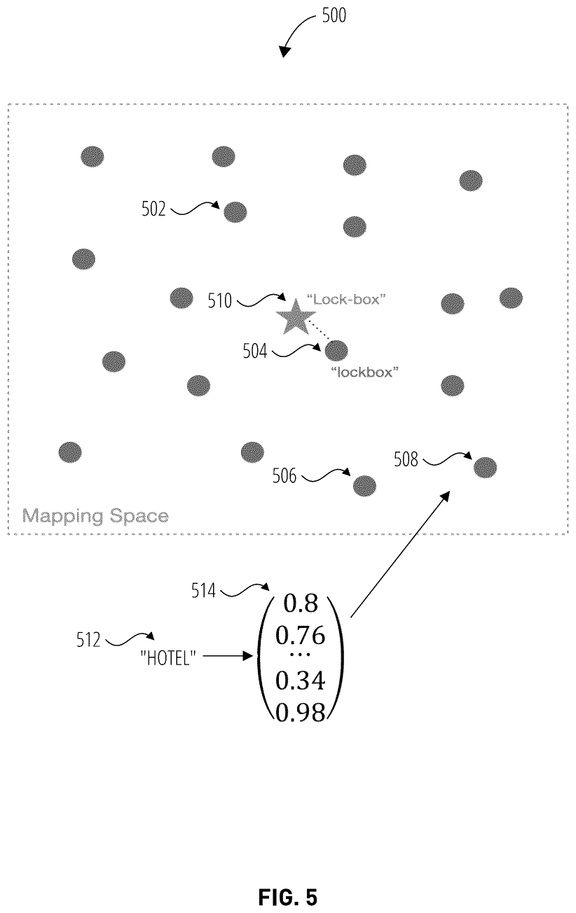

The EM system 210 is responsible for mapping the entities detected by the NER system 208 to a standardized taxonomy of listing attributes. In certain examples, the EM system 210 uses a word or a semantic vector space technique to find closest matching attributes in the standardized taxonomy. Further details of the semantic vector space technique are described with respect to FIG. 5. Accordingly, the EM system allows consolidating the diverse ways in which hosts and guests refer to the same listing attributes.

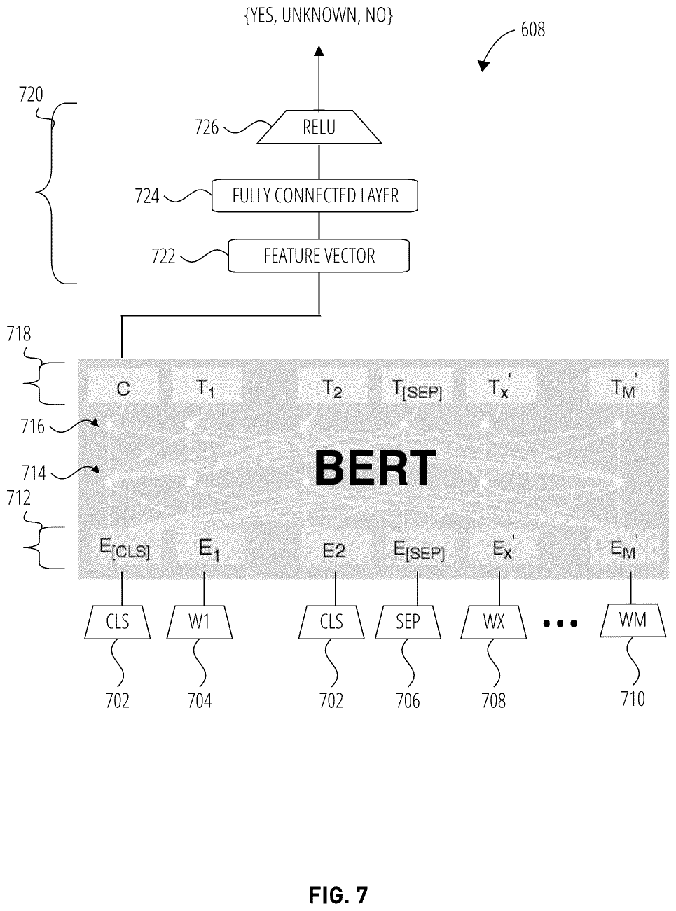

The ES system 212 also receives the entities derived by the NER system 208, and determines if a detected entity or attribute actually exists in the associated listing. The ES system 212 performs contextual text classification to infer the presence of amenities/facilities/features in the listing based on the textual data. In one example, a Bidirectional Encoder Representation from Transformers (BERT) model is to perform contextual text classification. Further details of the BERT model are provided in FIG. 7. The BERT model outputs labels and confidence scores to continually update the LAEP system 130. The ES system 212 is responsible for determining the existence of a detected phrase within a listing, as well as detecting usability of the detected phrase. In other words, the ES system 212 infers the existence of the detected phrases related to the listing associated with the source data and outputs a value to indicate if the attribute exists in the corresponding listing or not, as well as the confidence of such inference. For example, guests may talk or complain about something that does not exist in the listing, such as in customer support (CS) tickets. The ES system 212 helps to collect such information above and provides a more accurate representation of the listing's attributes with information from other sources to form a more holistic view.

The LAEP system 130 stores the standardized taxonomy of listing attributes in a data store 214, which includes a taxonomy database (DB) 216. The taxonomy DB 216 provides a searchable repository of attributes and confidence levels, and is used to create semantic vector space(s). In the depicted embodiment, an Attribute Prioritization System (APS) 218 is provided, which interacts with the taxonomy DB 216 to decide what kind of attributes have higher priority than others when using a supplemental review flow, among other applications. The supplemental review flow is part of a questionnaire provided to guests and/or hosts to improve ranking of attributes. For example, “WiFi” is typically ranked higher than “coffee maker.”

A structured data catalog 220 of attributes is thus created, which can be provided to other systems for various purposes. The structured data catalog 220 is a searchable knowledge base of listing attributes which includes listing attributes linked to corresponding listings. That is, the corresponding listings have provided the source textual data to create the mapping between entities in the listing and the listing attributes. The structured data catalog 220 includes a list of all found attributes from the taxonomy DB 216. The structured data catalog 220 is also used to automatically populate listing details and to detect discrepancies between promised and available amenities, among other uses.

FIG. 3 is a block diagram depicting a text processing pipeline 300 suitable for implementing the NER system 208, according to some examples. In the depicted example, input text 302 includes unstructured text documents associated with a various listings hosted on the listing network platform 128, such as a guest review 304, a message 306, a customer support (CS) ticket 308, a listing description 310, a check-in instruction 312, a house rule 314, and other text 316. The guest review 304 includes text entered by a guest to review a stay at a listing. The message 306 includes text of messages exchanged between guests and hosts. The CS ticket 308 includes text of customer support tickets and conversations between guests/hosts and support agents, including virtual support agents, provided by the listing network platform 128. The listing description 310 includes text that describes a listing published by the listing network platform 128. A check-in instruction 312 includes text of instructions for checking into a listing, such as where to park, codes to open locked doors, and so on. The house rule 314 includes text of rules for guests during their stay, such as rules concerning pets, smoking, unregistered guests, and so on. Other text includes other text sources related to the listings, such as text that may be found in online travel platforms.

The input text 302 is provided to a language detection system 318. The language detection system 318 uses a language prediction and filtering module 320 to detect languages used for the input text 302 and to filter out or otherwise pre-process the input text 302, for example, by correcting certain spelling errors such as double words. The preprocessed input text is then provided to a text processing pipeline 322 for derivation of entities. More specifically, a tokenizer 324 splits the input text sentences into tokens. Each token can be a word, a phrase, or a subword (e.g., a portion of a word). A tagger 326 then tags parts of speech, such as by tagging nouns, verbs, adjectives, and so on. The tagger 326 can use a dictionary, for example, to determine nouns, verbs, adjectives, and the like, to tag.

A parser 328 uses syntactic dependency techniques to parse out roots, direct objects, prepositional modifiers, and other syntactic objects. In one example, syntax-based rules are used by the parser to determine the roots, direct objects, prepositional modifiers, and the like. Tokens, tags, and/or parsings are then used by entity recognizer layer(s) 330 to derive one or more output entities 332. The use of the tokenizer 324, the tagger 326, and the parser 328 to provide inputs to the entity recognizer 330 results in a linguistic grammar-based approach to entity detection. In some examples, the pipeline 322 is a neural network, such as a convolutional neural network and/or a transformer neural network trained to identify named output entities 332 in the input text 302. Accordingly, the entity recognizer 330 includes one or more neural network layers. The convolutional neural network is also known as Shift Invariant or Space Invariant Artificial Neural Network (SIANN), based on the shared-weight architecture of the convolution kernels or filters that slide along input features and provide translation-equivariant responses known as feature maps. The transformer neural network uses stacked self-attention and feedforward layers to draw global dependencies between input and output more efficiently without recurrence, and includes parallelization capabilities. For example, instead of sequences, the transformer neural network processes an input sequence (e.g., text input text 302) in parallel through the use of self-attention. This allows capturing long-range dependencies in the textual data more effectively. The transformer neural network is composed entirely of encoder and decoder blocks stacked on top of each other. Each block has multi-head self-attention layers and feedforward neural network layers.

An entity prediction set 334 includes one or more entities having a format of <entity label, start index, end index>, where the entity label is text defining the entity (e.g., “lock-box”, “coffee maker”, “WiFi”, and so on), start index is a start location within an input text of the entity, and end index is an end location within the input text of the entity. In some examples, a training regime for the pipeline 322 (e.g, NER pipeline 322) uses a labeled dataset that is randomly split into training and testing datasets with a ratio of 9:1. The training dataset is then further split into training and validation datasets with a ratio of 9:1. The validation dataset is used for parameter sweeping. The parameter sweeping sweeps three parameters: number of epochs, dropout and batch size. The number of epochs is a hyperparameter that defines the number times that the learning algorithm will work through the entire training dataset. The batch size is a number of samples processed before the model is updated. Dropout is a regularization technique that randomly drops out (i.e., sets to zero) a certain percentage of neurons in each layer during training. This forces the neural network to learn multiple independent representations of the data, making the pipeline 322 more robust to the specific distribution of the training data.

In some cases, the model performance is less dependent on batch size, and reaches the best performance at dropout of approximately 0.2 and epochs between 7 to 9. As mentioned above, the model output is in the format of <entity label, start index, end index>tuple. Thus, only when the predicted entity matches exactly with the labeled entity, including entity label and entity span, will it be counted as True Positives (TPs). Otherwise, the predicted entity will be counted as either False Positives (FPs) or False Negatives (FNs). Then the precision, recall, and F1 score on each entity category and all categories can be calculated based on the TPs, FPs, and True Negatives (TNs). The entity prediction set 334 is then provided as input to the EM system 210 and the ES system 212.

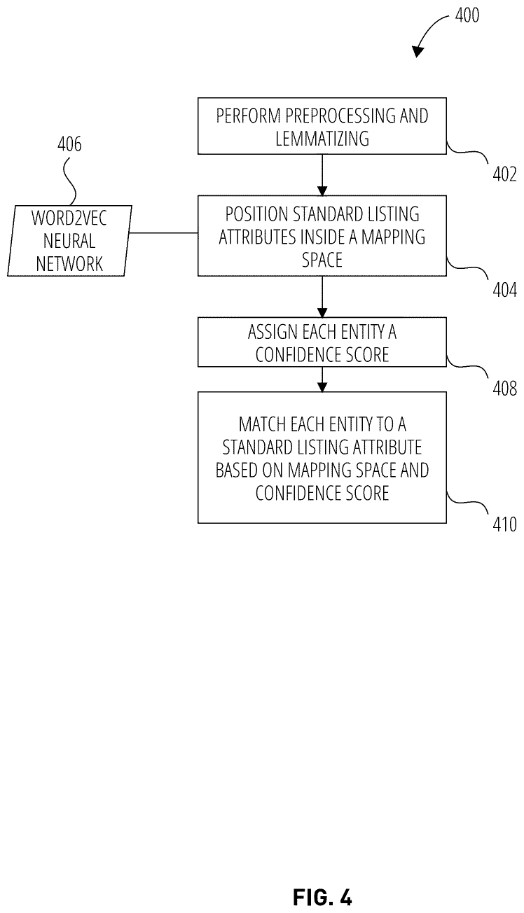

Turning now to FIG. 4, the figure is a flowchart of an entity mapping process 400 suitable for mapping entities (e.g., output entities 332) to attributes (e.g., attributes stored in the taxonomy DB 216), according to some examples. The output entities 332 derived via the NER system 208 have large numbers. In one example, more than 900 million phrases of interest incoming from 5 million unique phrases are detected yearly during operations the listing network platform 128. The detected phrases are very diverse in representing the same object due to different hosts or guests have different ways of expressing the same object. For example, more than twelve ways of expressing the standard listing attribute “lockbox” is observed, such as “lockbox”, “lock box”, “lock-box”, “box for the key”, “keybox”, “key safe locker”, “key box”, “key-box”, “codebox with the key”, “safelock box”, “lock keysafe”, “street lock box”, etc. Other phrases for “lockbox” include typing errors such as “ket box” and the like.

As an example, given around 900 listing attributes stored in the taxonomy DB 216, the listing attributes can be detected in phrases numbering around 5 million in one year. There are not only many detected phrases mapped to the same attribute, as in the “lockbox” example above, but also many phrases will have no attributes to be mapped to. In this context, a concept of confidence is introduced to the mapping so that rules are set up when a mapping cannot be performed, for example, by simple comparison (e.g., when an entity is the same as a stored attribute). At a high level, the labeling of a mapping is mainly done by reading the phrase of interest and the name of the listing attribute, and by judging if they mean the same thing. The judging decision is made mainly by the similarity of the two in semantic perspective. Accordingly, unsupervised learning is used by the EM system 210, instead of supervised learning.

In an unsupervised learning example, the entity mapping process 400 performed by the EM system 210 is as follows. The process 400, at block 402, preprocesses both the listing attributes and detected entities to use all lower case. The process then applies lemmatizing to remove unnecessary variations of words to both the detected entities and the listing attributes. For example, “Walking”, “walks”, “Walked”, and the like, are preprocessed and lemmatized to the single word “walk.” At block 404, the entity mapping process 400 then positions all the standard listing attributes (e.g., from the taxonomy DB 216) inside of a mapping space, such as a semantic vector space.

In one example, a word2vec neural network model 406 trained to use the input text 302 is applied to perform the positioning at block 404. The word2vec neural network model 406 learns word associations from a large corpus of text based on entity types, such as the amenity type, the facility type, the hospitality type, the location features type, the safety and security type, and the structural details type. Once trained, the word2vec neural network model 406 detects synonymous words or suggests additional words for a partial sentence. The word2vec neural network model 406 represents each distinct word with a particular list of numbers called a vector. A mathematical function (e.g., cosine similarity) then indicates the level of semantic similarity between the words represented by those vectors.

More specifically, the word2vec neural network 406 is trained on a large corpus of text data, such as a collection of listings, news articles, books, and/or web pages. The word2vec neural network 406 model is based on the idea that the meaning of a word can be inferred from the context in which it appears. In other words, words that often appear in similar contexts are likely to have similar meanings. The word2vec neural network 406 is trained using one of two architectures: Skip-gram or Continuous Bag of Words (CBOW). In Skip-gram, the word2vec neural network 406 predicts the context words (surrounding words) given a target word. In CBOW, the word2vec neural network 406 predicts the target word based on its context words.

During training, the word2vec neural network 406 learns vector representations for each word in the vocabulary. The vector representation for a word is typically a high-dimensional vector, and the specific values in the vector are learned during the training process. These values are real numbers and encode semantic information about the word and its relationships with other words. The dimensionality of these vectors is determined by a hyperparameter called the embedding dimension, and common choices include dimensions like 50, 100, 200, or 300.

An example of what a vector representation for a word might look like in a Word2Vec model with a hypothetical embedding dimension of 3 (for simplicity, the actual word2vec neural network 406 will have higher dimensions):
Word: “apple”
Vector representation: [0.2, −0.3, 0.8]

In this example, the word “apple” is represented by a 3-dimensional vector. The values in the vector (0.2, −0.3, 0.8) are learned during the training process and encode information about the word's semantic properties and its co-occurrence patterns with other words in the training corpus. The vector representations are not directly interpretable by humans, but they capture semantic relationships between words in a continuous vector space. Words with similar meanings or that often appear in similar contexts will have vector representations that are closer to each other in this space. For instance, in the trained word2vec neural network 406, the vectors for words like “apple” and “fruit” might be closer together because they share semantic similarities. The actual values in these vectors depend on the training data, the architecture used (Skip-gram or CBOW), and the specific learning process. As the word2vec neural network 406 learns from the training data, it maps words to vectors in such a way that words with similar meanings or contexts have similar vector representations. This captures semantic relationships between words. For example, in the trained word2vec neural network 406, the vectors for “king” and “queen” may be closer to each other in the vector space compared to the vectors for “king” and “cat.”

For a preprocessed detected phrase from the text, the EM system 210 finds, at block 408, the closest listing attribute by cosine similarity. Cosine similarity is the cosine of the angle between the vectors; that is, it is the dot product of the vectors divided by the product of their lengths. The EM system 210 then assigns, at block 408, the cosine similarity as the confidence score. In some examples, the EM system 210 also outputs any listing attributes that have similarity above a pre-specified threshold (e.g., over 0.7) as backup candidates, which are termed qualified candidates. By keeping the qualified candidates, downstream business applications can leverage the qualified candidates to make corrections when the top mapping (the one with the most confidence) is not the correct one. The entity is then matched to one or more listing attributes based on the mapping space and confidence score. For example, for each entity, the confidence score is used to find one or more listing attributes in the mapping space, and then the closest or “top” listing attribute is chosen as a match. However, since the confidence of mapping is a float number between 0 and 1, a threshold of “No Mapping” is used. In one example, the threshold value used is 0.7. If there are no mappings with confidence above this threshold value, then entity mapping process 400 determines that there is “No Mapping.”

It may be beneficial to illustrate the use of a mapping space, such as a semantic vector space, to match entities to listing attributes, according to some examples. Turning now to FIG. 5, the figure illustrates a semantic vector space 500 suitable for use by the EM system 210 to map entities into a standardized taxonomy of listing attributes stored in the structured data catalog 220, in accordance with some examples. In the depicted example, all dots inside of the semantic vector space 500, such as dots 502, 504, 506 and 508, are listing attributes that have been positioned as described above with respect to the entity mapping process 400, block 404. More specifically, the word2vec neural network 406 has been applied to listing attributes stored in the taxonomy DB 216 and the resulting vector for each entity then places the entity in the semantic vector space 500.

As depicted in the figure, the listing attribute “lockbox” corresponds to dot 504. The entity 510 “Lock-box” is then processed, for example, via the entity mapping process 400, to determine that dot 504 is the closest listing attribute and that the entity 510 has a confidence score above the confidence threshold. The listing attribute “lockbox” then becomes the top listing attribute for the entity 510 “Lock-box.” Likewise, an entity 512 “HOTEL” is compared to various dots in the mapping space to determine, via cosine similarity vector 514, that the dot 508 is representative of the closest listing attribute. The entity's confidence score is then used to determine if there is a mapping, based on the confidence score exceeding the confidence threshold. By using a mapping space approach with confidence scores, a large number of entities is processed, in some cases, in parallel, to determine best matches with the listing attributes.

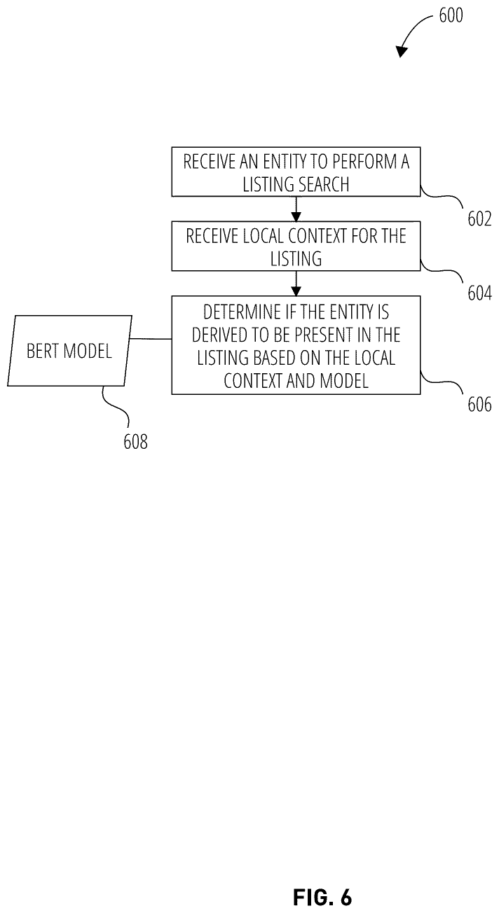

FIG. 6 is a flowchart of a process 600 suitable for determining if an entity is present in a listing, according to some examples. In the depicted example, a user, such as a guest, is looking for one or more specific entities that may not be explicitly described as part of listings included in the listing network platform 128. For example, a guest may be looking for an entity such as a “crib” or a “highchair” for their infant, for a “swimming pool”, and so on. In the depicted embodiment, the process 600 receives, at block 602, an entity that is being searched for, such as “swimming pool.”

The process 600, at block 604, retrieves a local context representative of the listing being searched. In some examples, the local context includes a mapping between the entity being searched and a listing attribute stored in the taxonomy DB 216. For example, a mapping between an entity “swimming pool” and a listing attribute “pool” has already been created previously, based on a messaging exchange (e.g., message 306) between a host and another guest, for the current listing being searched. The messaging exchange, in one example, is as follows: “Guest: Does your listing have a swimming pool?” “Host: Yes, there is a swimming pool in the backyard!”

Accordingly, the local context also includes input text (e.g., guest review 304, message 306, customer support (CS) ticket 308, listing description 310, check-in instruction 312, house rule 314, and/or other text 316) that was used to create the original mapping for the listing. A model, such as a Bidirectional Encoder Representation from Transformers (BERT) model 608, is then applied to the entity and the local context, such as the mapping and input text, to determine, at block 606, if the entity is found in the listing. The BERT model 608 will provide a discrete output of {Yes, Unknown, No} representative of the entity being present in the listing, not being able to determine if the entity is present in the listing, and the entity not being present in the listing, respectively. In some examples, the BERT model 608 will also provide a confidence level (e.g., between 0%-100%) for the result, with 0% denoting no confidence and 100% denoting full confidence. Likewise, the BERT model 608 is queried for usability (e.g., “is the swimming pool usable?”) and/or local sentiment (e.g., “the swimming pool is clean and beautiful”!”). Output values returned are {Yes, Unknown, No}, as well as a confidence level in the output values. More details of the BERT model 608 are described with respect to FIG. 7.

Turning now to FIG. 7, the figure is a block diagram illustrating details of the BERT model 608, according to some examples. In the depicted example, the BERT model 608 is a trained neural network receiving as input tokens 702-710 representing text to be searched. The BERT model 608 BERT uses bidirectional training of transformers, while other transformer networks were unidirectional. The CLS token 702 represents a full sequence, while W1 token 704 is a word, such as an entity to be searched (e.g., “crib”). A SEP token 706 represents a separate sequence, while Wx and Wm tokens 708, 710, represent other words to be searched.

The BERT model 608 encodes input tokens 702-710 via multiple transformer encoder blocks 712 sequentially. The BERT model 608 is built on the transformer architecture, which includes multiple layers 714, 716 of self-attention mechanisms and feedforward neural networks.

Each layer 714, 716 of the transformer processes the input tokens 702-710 in parallel, allowing the model to capture contextual information from both directions (left-to-right and right-to-left), hence the “bidirectional” nature of the BERT model 608. The self-attention mechanism helps the BERT model 608 capture relationships between words that are relevant to understanding the meaning of the text. After pre-training on a large text corpus, the BERT model 608 is fine-tuned for specific natural language processing (NLP) tasks with a relatively small amount of task-specific labeled data. During fine-tuning, task-specific layers, such as a classification layer 718, are added on top of the pre-trained BERT model 608. The entire model is then fine-tuned on the task-specific dataset, such as the input text 302, using supervised learning, where the model learns to make predictions specific to the task, such as sentiment analysis, question answering, etc.

The BERT model 608 also includes a head section 720, which has a feature vector 722, a fully connected layer 724, and a ReLu linear projection 726. The feature vector 722 represents the learned, dense representation of the input text in a high-dimensional space, capturing the contextual and semantic information required for various downstream NLP tasks. The fully connected layer 724 acts as the interface between the rich contextualized representations, such as the feature vector 722 learned by the BERT model 608, and the specific task's output requirements. It learns to map the BERT features to the desired output space, allowing the BERT model 608 to make predictions or perform other relevant tasks. The ReLu linear projection 726 applies a linear transformation to the BERT feature vector 722 followed by a ReLU activation function. This step helps in mapping the contextualized embeddings to a suitable space for the specific downstream NLP task and introduces non-linearity into the model to capture task-specific patterns, such as deriving the {Yes, Unknown, No} labels for the input tokens 702-710.

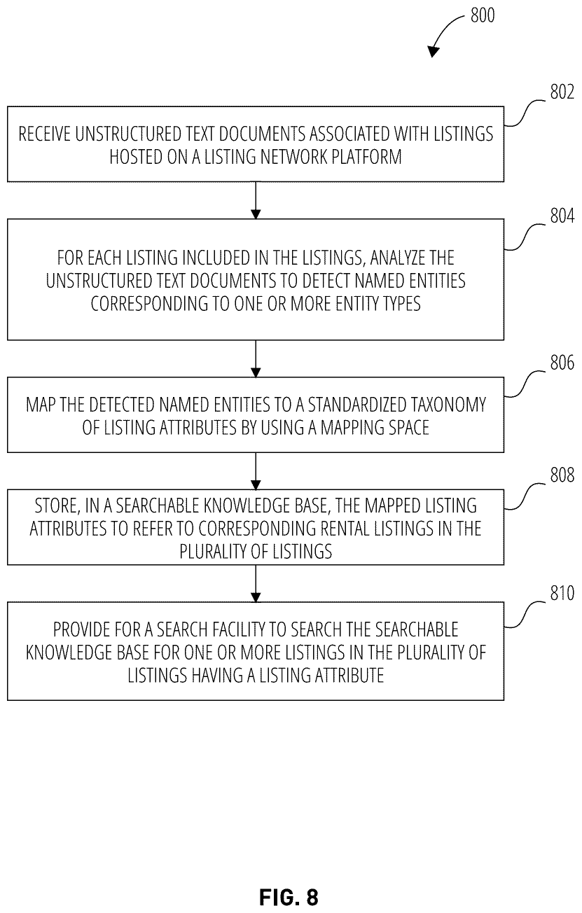

FIG. 8 is a flowchart of a process 800 suitable for providing a searchable knowledge base of listing attributes, according to some examples. In the depicted embodiment, the process 800, at block 802, receives unstructured text documents associated with listings hosted on a listing network platform, such as the listing network platform 128. The unstructured text includes input text 302, such as guest reviews 304, messages 306, customer support (CS) tickets 308, listing descriptions 310, check-in instructions 312, house rules 314, and other texts 316.

The process 800, at block 804, then iterates through each list included in the listings to analyze the unstructured text documents. The analysis detects named entities, with each detected entity having an entity type. As mentioned earlier, in one example, the text processing pipeline 322 is used to detect named entities from the input text 302. The text processing pipeline 322 uses a trained neural network, e.g., the entity recognizer 330, in addition to the tokenizer 324, tagger 326, and the parser 328, to derive the output entities 332.

At block 806, the process 800 then maps the detected named entities to a standardized taxonomy of listing attributes by using a mapping space, such by applying the EM system 210 as described above. In one example, the mapping space is the semantic vector space 500. The process 800 then stores, via the searchable knowledge base 220 at block 808, the mapped listing attributes that refer to corresponding listings. That is, the mapped listing attributes are stored in a manner (or with added information) that links back to the listing(s) used to derive the mapped listing attributes.

At block 810, the process 800 provides for a search facility to search the searchable knowledge base 220 for one or more listings by listing attribute. That is, a listing attribute, such as “crib”, can be entered into the search facility, and the search facility will then retrieve any listings that include the desired listing attribute. In one example, the search facility is a graphical user interface (GUI) that is provided by the listing network platform 128 to search the searchable knowledge base 220.

### Machine Architecture

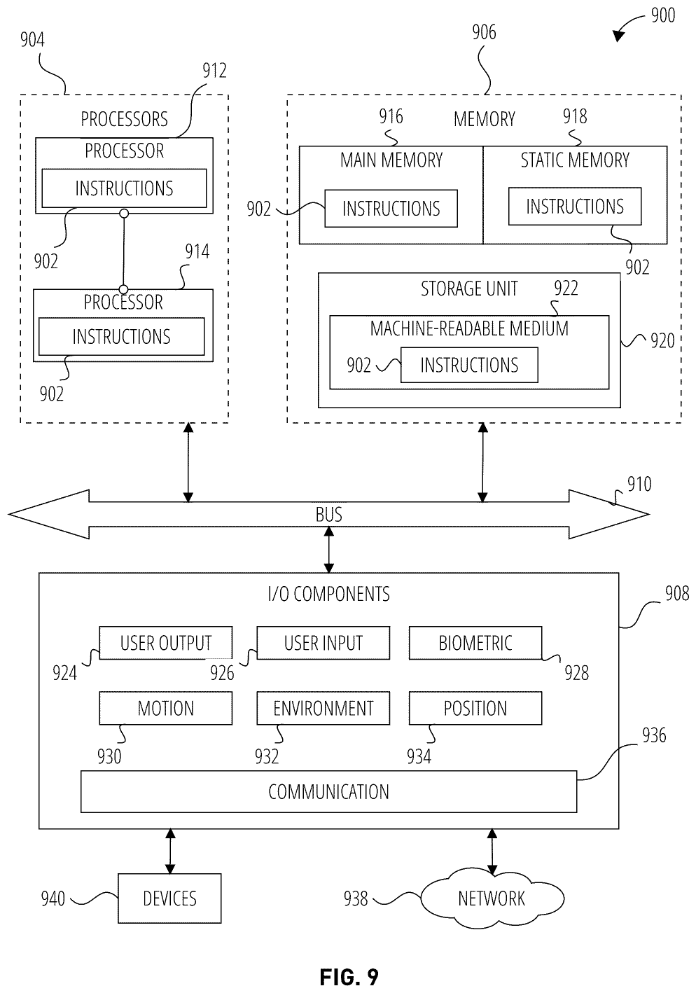

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise the user system 102 or any one of multiple server devices forming part of the server system 110. In some examples, the machine 900 may also comprise both client and server systems, with certain operations of a particular method or algorithm being performed on the server-side and with certain operations of the particular method or algorithm being performed on the client-side.

The machine 900 may include processors 904, memory 906, and input/output I/O components 908, which may be configured to communicate with each other via a bus 910. In an example, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 912 and a processor 914 that execute the instructions 902. The term “processor” is intended to include multi-core processors that may comprise two or more independent processors (sometimes referred to as “cores”) that may execute instructions contemporaneously. Although FIG. 9 shows multiple processors 904, the machine 900 may include a single processor with a single-core, a single processor with multiple cores (e.g., a multi-core processor), multiple processors with a single core, multiple processors with multiples cores, or any combination thereof.

The memory 906 includes a main memory 916, a static memory 918, and a storage unit 920, both accessible to the processors 904 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 930 include acceleration sensor components (e.g., accelerometer), gravitation sensor components, rotation sensor components (e.g., gyroscope).

The environmental components 932 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 934 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 908 further include communication components 936 operable to couple the machine 900 to a network 938 or devices 940 via respective coupling or connections. For example, the communication components 936 may include a network interface component or another suitable device to interface with the network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the processors 904) and storage unit 920 may store one or more sets of instructions and data structures (e.g., software) embodying or used by any one or more of the methodologies or functions described herein. These instructions (e.g., the instructions 902), when executed by processors 904, cause various operations to implement the disclosed examples.

The instructions 902 may be transmitted or received over the network 938, using a transmission medium, via a network interface device (e.g., a network interface component included in the communication components 936) and using any one of several well-known transfer protocols (e.g., hypertext transfer protocol (HTTP)). Similarly, the instructions 902 may be transmitted or received using a transmission medium via a coupling (e.g., a peer-to-peer coupling) to the devices 940.

### Software Architecture

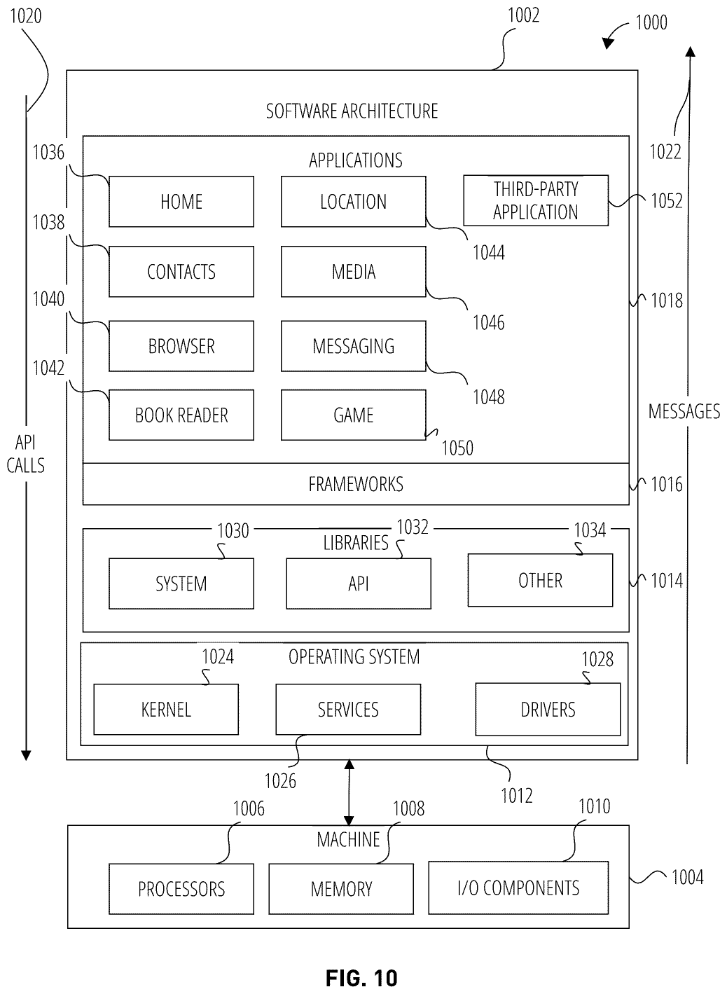

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematical functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

What is claimed is:

1. A system comprising:
one or more processors; and
a memory storing instructions that, when executed by the one or more processors, cause the one or more processors to:
receive unstructured text documents associated with a plurality of listings hosted on a listing network platform;
for each listing in the plurality of listings, analyze the unstructured text documents to detect named entities corresponding to one or more entity types using a first trained neural network model;
map the detected named entities to a standardized taxonomy of listing attributes by using a mapping space;
store, in a searchable knowledge base, the mapped listing attributes to refer to corresponding listings in the plurality of listings; and
provide for a search facility to search the searchable knowledge base for one or more listings in the plurality of listings having a listing attribute.

2. The system of claim 1, wherein the first trained neural network model is part of a text processing pipeline configured to:
receive as input a text filtered from the unstructured text documents;
tokenize the text to produce one or more tokens;
tag each token in the one or more tokens to assign parts of speech to each token;
parse the tagged one or more tokens to derive one or more syntactic objects; and
apply the first trained neural network model to the one or more syntactic objects to detect the named entities.

3. The system of claim 2, wherein the parts of speech comprise a noun, a verb, or an adjective, and wherein the one or more syntactic objects comprise a root, a direct object, or a prepositional modifier.

4. The system of claim 2, wherein the instructions further cause the one or more processors to predict a language of the unstructured text documents to filter the text.

5. The system of claim 1, wherein the first trained neural network model comprises a convolutional neural network, a transformer neural network, or a combination thereof, trained via a labeled dataset that is randomly split into training and testing datasets.

6. The system of claim 1, wherein the instructions further cause the one or more processors to map the detected named entities to the standardized taxonomy of the listing attributes by:
performing a preprocessing and a lemmatizing of the detected named entities;
assigning each of the detected named entities a confidence score; and
matching each of the detected named entities to one or more of the listing attributes based on the confidence score and the mapping space.

7. The system of claim 6, wherein the instructions further cause the one or more processors to derive the confidence score by applying a mathematical function that derives a cosine similarity, and by using the cosine similarity as the confidence score.

8. The system of claim 6, wherein the mapping space comprises a semantic vector space.

9. The system of claim 1, wherein the listing attributes are positioned in the mapping space by applying a second trained neural network model.

10. The system of claim 9, wherein the second trained neural network model comprises a word2vec neural network model trained to learn word associations to provide vectors as output and wherein the vectors are used to position each of the listing attributes.

11. The system of claim 1, wherein the instructions further cause the one or more processors to validate that a listing attribute in the listing attributes is present in a listing in the plurality of listings via an entity scoring.

12. The system of claim 11, wherein the entity scoring comprises a second trained neural network model used to validate that the listing attribute is present in the listing.

13. The system of claim 12, wherein the second trained neural network model comprises a Bidirectional Encoder Representation from Transformers (BERT) model.

14. The system of claim 13, wherein the BERT model is configured to receive as input, tokens representing the listing attribute and the listing and to provide as output, one or more labels representative of whether the listing attribute is present or not present in the listing.

15. A method, comprising:
receiving, via one or more processors, unstructured text documents associated with a plurality of listings hosted on a listing network platform;
for each listing in the plurality of listings, analyzing, via the one or more processors, the unstructured text documents to detect named entities corresponding to one or more entity types using a first trained neural network model;
mapping, via the one or more processors, the detected named entities to a standardized taxonomy of listing attributes by using a mapping space;
storing, in a searchable knowledge base, the mapped listing attributes to refer to corresponding listings in the plurality of listings; and
providing, via the one or more processors, for a search facility to search the searchable knowledge base for one or more listings in the plurality of listings having a listing attribute.

16. The method of claim 15, wherein the first trained neural network is part of a text processing pipeline configured to:
receive as input a text filtered from the unstructured text documents;
tokenize the text to produce one or more tokens;
tag each token in the one or more tokens to assign parts of speech to each token;
parse the tagged one or more tokens to derive one or more syntactic objects; and
apply the first neural network model to the one or more syntactic objects to detect the named entities.

17. The method of claim 15, wherein mapping the detected named entities to the standardized taxonomy of the listing attributes further comprises:
performing a preprocessing and a lemmatizing of the detected named entities;
assigning each of the detected named entities a confidence score; and
matching each of the detected named entities to one or more of the listing attributes based on the confidence score and the mapping space.

18. A non-transitory machine-readable medium storing instructions that, when executed by a computer system, cause the computer system to perform operations comprising:
receiving, via one or more processors, unstructured text documents associated with a plurality of listings hosted on a listing network platform;
for each listing in the plurality of listings, analyzing, via the one or more processors, the unstructured text documents to detect named entities corresponding to one or more entity types using a first trained neural network model;
mapping, via the one or more processors, the detected named entities to a standardized taxonomy of listing attributes by using a mapping space;
storing, in a searchable knowledge base, the mapped listing attributes to refer to corresponding listings in the plurality of listings; and
providing, via the one or more processors, for a search facility to search the searchable knowledge base for one or more listings in the plurality of listings having a listing attribute.

19. The non-transitory machine-readable medium of claim 18, wherein the first trained neural network is part of a text processing pipeline configured to:
receive as input a text filtered from the unstructured text documents;
tokenize the text to produce one or more tokens;
tag each token in the one or more tokens to assign parts of speech to each token;
parse the tagged one or more tokens to derive one or more syntactic objects; and
apply the first neural network model to the one or more syntactic objects to detect the named entities.

20. The non-transitory machine-readable medium of claim 18, wherein mapping the detected named entities to the standardized taxonomy of the listing attributes further comprises:
performing a preprocessing and a lemmatizing of the detected named entities;
assigning each of the detected named entities a confidence score; and
matching each of the detected named entities to one or more of the listing attributes based on the confidence score and the mapping space.
